(19) United States
(12) Patent Application Publication
(10) Pub. No.: US 2019/0081807 A1
(43) Pub. Date: Mar. 14, 2019

(54) METHODS AND SYSTEMS OF MANAGING ONLINE CHAT MESSAGES

(71) Applicant: BHAVESH soni, IRVING, TX (US)

(72) Inventor: BHAVESH soni, IRVING, TX (US)

(21) Appl. No.: 15/915,060

(22) Filed: Mar. 7, 2018

Related U.S. Application Data
(60) Provisional application No. 62/467,822, filed on Mar. 7, 2017.

(51) Int. Cl. H04L 12/18; H04L 12/58

(52) U.S. Cl. CPC H04L 12/1813; H04L 51/043; H04L 51/38; H04L 51/10; H04L 51/046

(57) ABSTRACT

In one aspect, a computerized method useful for providing a dynamic grouping of a set of shared-object chat messages comprising. The method includes the step of enabling a creator of a shared object to auto-subscribe to a dynamic grouping of shared-object chat messages service. The method includes the step of determining a proximity to a creator of a shared object on mobile-device grape. The method includes the step of determining a proximity to a creator in a time dimension on a chat message passing. The method includes the step of determining a total number of other auto-subscribes from a mobile device that are capped. The method includes the step of editing a frequency of the shared object.

### CROSS-REFERENCE TO RELATED APPLICATIONS

This application is a claims priority from U.S. Provisional Application No. 62467822, titled METHODS AND SYSTEMS OF MANAGING ONLINE CHAT MESSAGES and filed Mar. 7, 2017. This application is hereby incorporated by reference in its entirety.

### BACKGROUND

### 1. Field

The embodiments herein generally relate electronic messaging and more specifically o methods and systems of managing online chat messages.

### 2. Related Art

There is a need to digitize the meaning human conversations and remove noise and ambiguity from everyday decision-making. Accordingly, instant messaging can be reimagined for effortless consensual and coordination among a clique of members.

### SUMMARY OF INVENTION

A computerized method useful for providing a dynamic grouping of a set of shared-object chat messages comprising. The method includes the step of enabling a creator of a shared object to auto-subscribe to a dynamic grouping of shared-object chat messages service. The method includes the step of determining a proximity to a creator of a shared object on mobile-device grape. The method includes the step of determining a proximity to a creator in a time dimension on a chat message passing. The method includes the step of determining a total number of other auto-subscribes from a mobile device that are capped. The method includes the step of editing a frequency of the shared object.

### BRIEF DESCRIPTION OF THE DRAWINGS

FIG. 1 illustrates an example system for managing online chat messages, according to some embodiments.

FIG. 2 depicts an exemplary computing system that can be configured to perform any one of the processes provided herein.

FIG. 3 is a block diagram of a sample computing environment that can be utilized to implement various embodiments.

FIG. 4 illustrates an example process of providing shared-object in a chat message, according to some embodiments.

FIGS. 5A-G illustrate a set of example screen shots illustrating example free-form shared objects, according to some embodiments.

FIG. 6 illustrates an example screen shot illustrating public-health related free-form shared object, according to some embodiments.

FIG. 7 illustrates an example screen shot illustrating a composite-shared object that includes another shared object, according to some embodiments.

FIG. 8 illustrates an example process for managing privacy controls of a shared-object chat message, according to some embodiments.

FIG. 9 illustrates an example screenshot for managing privacy controls of a shared-object chat message, according to some embodiments.

FIG. 10 illustrates an example process for analyzing data acquired through user's interaction, according to some embodiments.

FIG. 11 illustrates an example process for providing dynamic grouping of shared-object chat messages, according to some embodiments.

FIG. 12 illustrates a pair of example screen shots of example business services, according to some embodiments.

FIG. 13 illustrates an example set of screen shots implemented in a matching process, according to some embodiments.

FIG. 14 illustrates an example set of screen shots, according to some embodiments.

FIG. 15 illustrates an example set of screen shots, according to some embodiments.

FIG. 16 illustrates an example pair of screen shots in a channel example, according to some embodiments.

FIG. 17 illustrates an example pair of screen shots of a large clique channel example, according to some embodiments.

FIG. 18 illustrates an example pair of screen shots of a live clique channel example, according to some embodiments.

FIG. 19 illustrates an example pair of screen shots, according to some embodiments.

FIG. 20 illustrates an example set of screen shots of an exchange example, according to some embodiments.

The Figures described above are a representative set and are not an exhaustive with respect to embodying the invention.

### DESCRIPTION

Disclosed are a system method and article of manufacture for methods and systems of managing online chat messages. The following description is presented to enable a person of ordinary skill in the art to make and use the various embodiments. Descriptions of specific devices, techniques, and applications are provided only as examples. Various modifications to, the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth, in other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Definitions

Example definitions for some embodiments are now provided.

Application programming interface (API) can specify how software components of various systems interact with each other.

Cloud computing can involve deploying groups of remote servers and/or software networks that allow centralized data storage and online access to computer services or resources. These groups of remote serves and/or software networks can be a collection of remote computing services.

Gamification is the application of game-design elements and game principles in non-game contexts. Gamification commonly employs game design elements to improve user engagement, organizational productivity, flow, learning, crowdsourcing, etc.

Mobile device can include a handheld computing device that includes an operating system (OS), and can run various types of application software, known as apps. Example handheld devices can also be equipped with various context sensors (e.g. biosensors, physical environmental sensors, etc.), digital cameras, Wi-Fi, Bluetooth, and/or GPS capabilities. Mobile devices can allow connections to the Internet and/or other Bluetooth-capable devices, such as an automobile, a wearable computing system and/or a microphone headset. Exemplary mobile devices can include smart phones, tablet computers, optical head-mounted display (OHMD) (e.g. Google Glass®), virtual reality head-mounted display, smart watches, other wearable computing systems, etc.

Online chat may refer to any kind of communication over the Internet that offers a real-time transmission of text messages from sender to receiver. In some examples, online chat may include various point-to-point communications as well as multicast communications from one sender to many receivers and voice and video chat and/or may be a feature of a web conferencing service. Online chat can include a direct text-based or video-based (e.g. webcams), one-on-one chat or one-to-many group chat (formally also known as synchronous conferencing), using tools such as instant messengers, Internet Relay Chat (IRC), talkers, MUDs, etc.

Example Computer Architecture and Systems

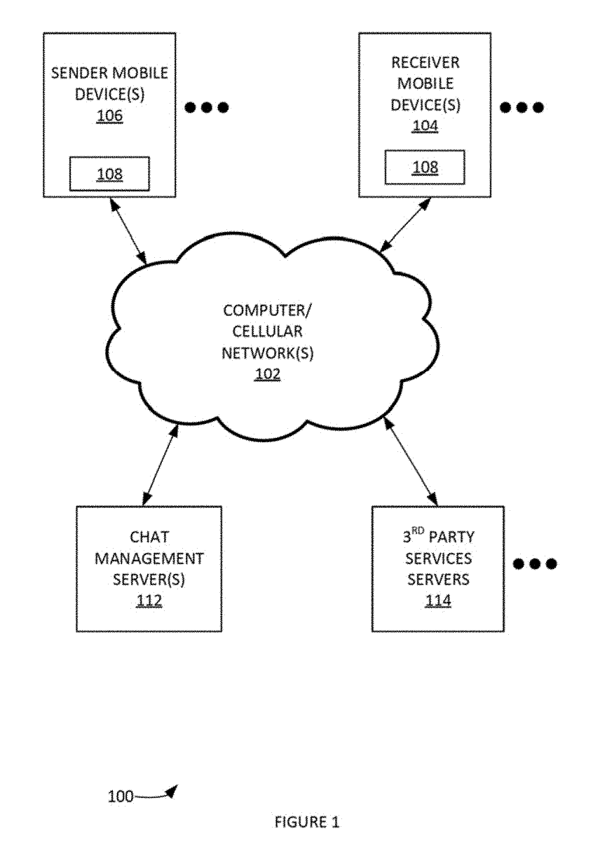

FIG. 1 illustrates an example system 100 for managing online chat messages, according to some embodiments. System 100 can include various computer and/or cellular data networks 100. Networks 100 can include the Internet, text messaging networks (e.g. short messaging service (SMS) networks, multimedia messaging service (MMS) networks, proprietary messaging networks, instant messaging service networks, email systems, etc. Networks 100 can be used to communicate messages and/or other information from the various entities of system 100.

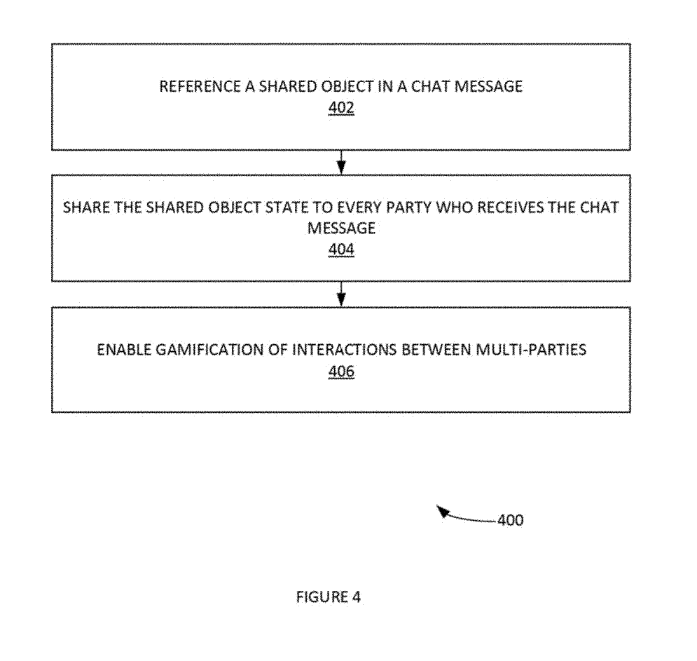

Sender mobile device(s) 106 and receiver mobile device(s) 104 can include a chat messaging application 108. Chat messaging application 108 can provide for various types of shared-object in a chat message. Example shared-objects in chat messages are provided in the examples herein. For example, chat messaging application 108 (and/or chat management sever 112) can be used to implement the screen shots and/or process discussed in FIGS. 4-20 infra.

System 100 can include chat management server(s) 112. Chat management servers 112 can enable users to send and receive shared-objects in chat messages (e.g. using a mobile device application, etc.). Chat management servers 112 can be used to implement the screen shots and/or process discussed in FIGS. 4-20 infra. Chat management servers 112 can include web servers, geo-location systems, email servers, IM servers, database management systems, search engines, electronic payment servers, member management systems, administration systems, machine-learning systems, ranking systems, optimizations systems, text messaging systems, etc. Third-party services server(s) 114 can provided various third-party services (e.g. mapping services, marketing databases/services, geolocation services, online social networking services, machine-learning services, search engine services, etc.).

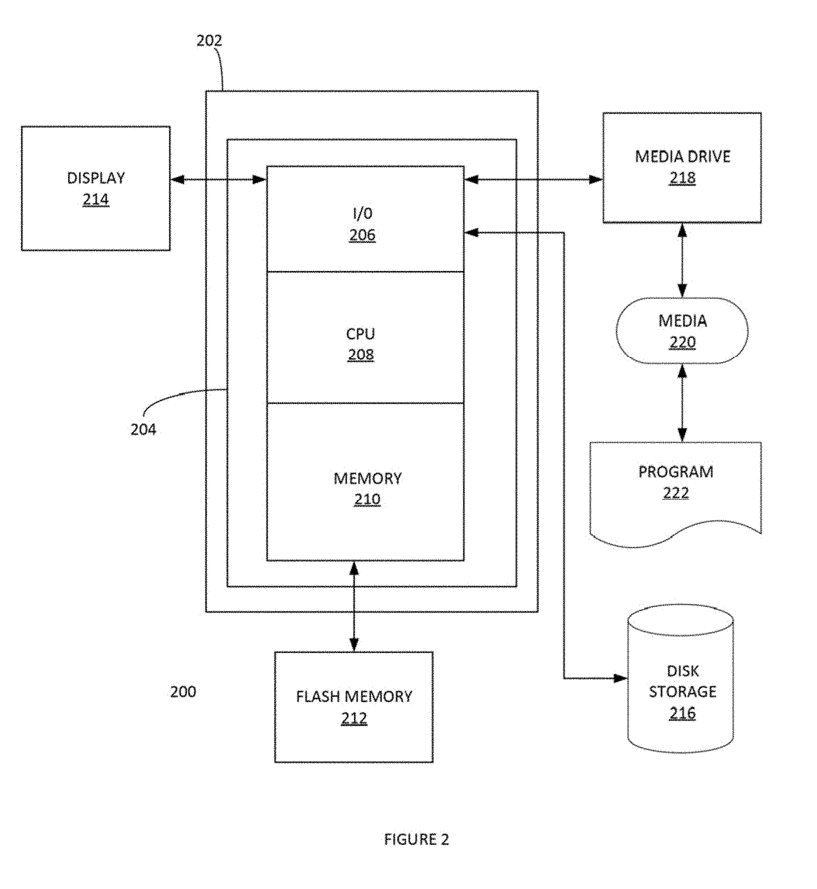

FIG. 2 depicts an exemplary computing system 200 that can be configured to perform any one of the processes provided herein. In this context, computing system 200 may include, for example, a processor, memory, storage, and I/O devices (e.g., monitor, keyboard, disk drive, Internet connection, etc.). However, computing system 200 may include circuitry or other specialized hardware for carrying out some or all aspects of the processes. In some operational settings, computing system 200 may be configured as a system that includes one or more units, each of which is configured to carry out some aspects of the processes either in software, hardware, or some combination thereof.

FIG. 2 depicts computing system 200 with a number of components that may be used to perform any of the processes described herein. The main system 202 includes a motherboard 204 having an I/O section 206, one or more central processing units (CPU) 208, and a memory section 210, which may have a flash memory card 212 related to it. The I/O section 206 can be connected to a display 214, a keyboard and/or other user input (not shown), a disk storage unit 216, and a media drive unit 218. The media drive unit 218 can read/write a computer-readable medium 220, which can contain programs 222 and/or data. Computing system 200 can include a web browser. Moreover, it is noted that computing system 200 can be configured to include additional systems in order to fulfill various functionalities. Computing system 200 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

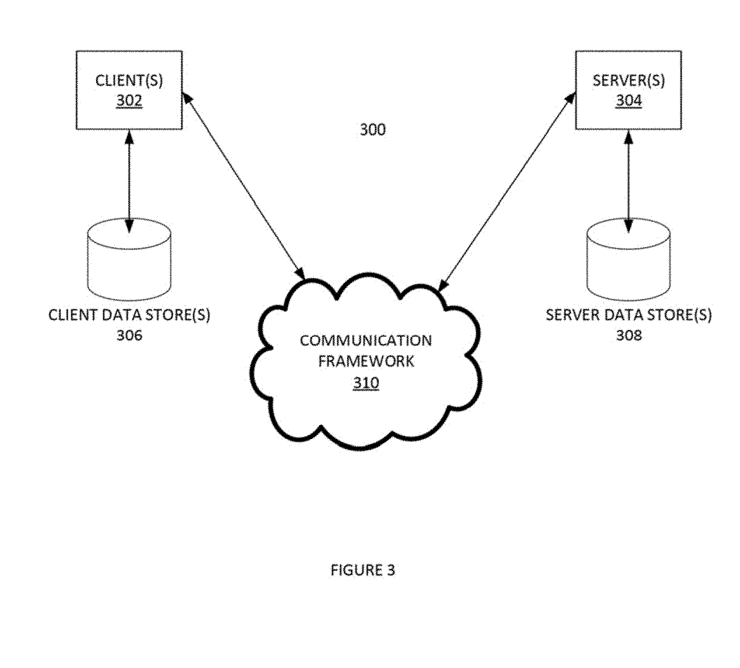

FIG. 3 is a block diagram of a sample computing environment 300 that can be utilized to implement various embodiments. The system 300 further illustrates a system that includes one or more client(s) 302. The client(s) 302 can be hardware and/or software (e.g., threads, processes, computing devices). The system 300 also includes one or more server(s) 304. The server(s) 304 can also be hardware and/or software (e.g., threads, processes, computing devices). One possible communication between a client 302 and a server 304 may be in the form of a data packet adapted to be transmitted between two or more computer processes. The system 300 includes a communication framework 310 that can be employed to facilitate communications between the client(s) 302 and the server(s) 304. The client(s) 302 are connected to one or more client data store(s) 30 that can be employed to store information local to the client(s) 302. Similarly, the server(s) 304 are connected to one or more server data store(s) 308 that can be employed to store information local to the server(s) 304. In some embodiments, system 300 can instead be a collection of remote computing services constituting a cloud-computing platform.

Exemplary Methods

Various online chat methods and techniques are now provided. A chat-message system cats be provided to implement the following processes.

Online Chat Shared Objects

FIG. 4 illustrates an example process 400 of providing a shared-object in a chat message, according to some embodiments. In step 402, process 400 can reference a shared object (e.g. a ‘sticky’) in a chat message. In step 404, process 400 can share the shared object state to every party who receives the chat message. It is noted that the shared object state can depend on a privacy policy. In step 406, process 400 can enable the gamification of between multiple parties utilizing the shared objects (e.g. see infra).

A shared object can be of, inter alia, two types. A first type of shared object can a free-form shared object. Another type of shared object can be a composite shared object. A composite shared object can be a shared object with many forms. A composite shared object contains other shared objects.

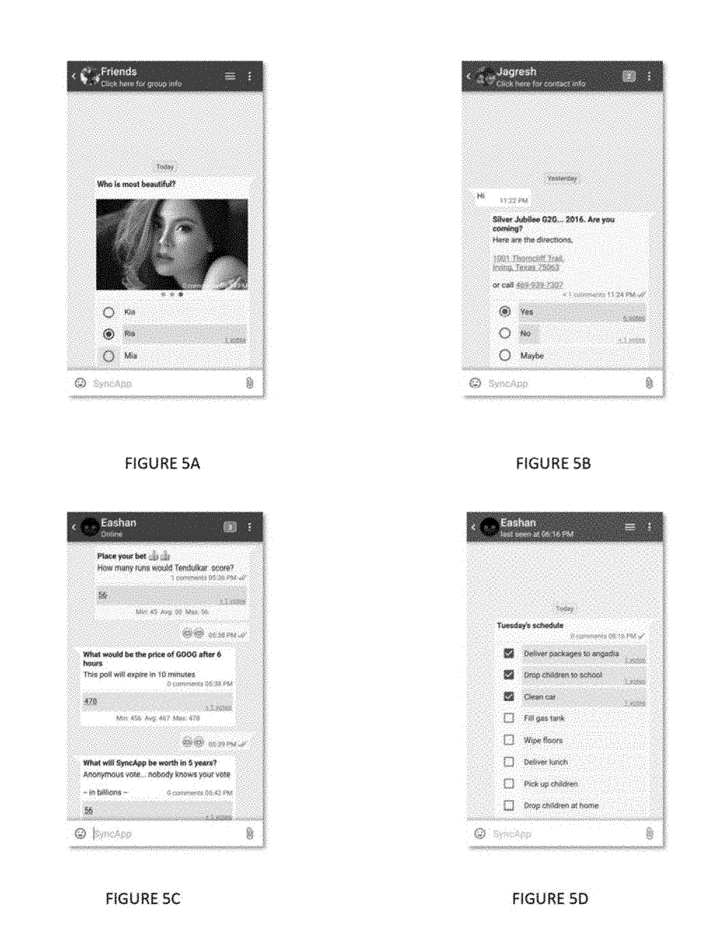

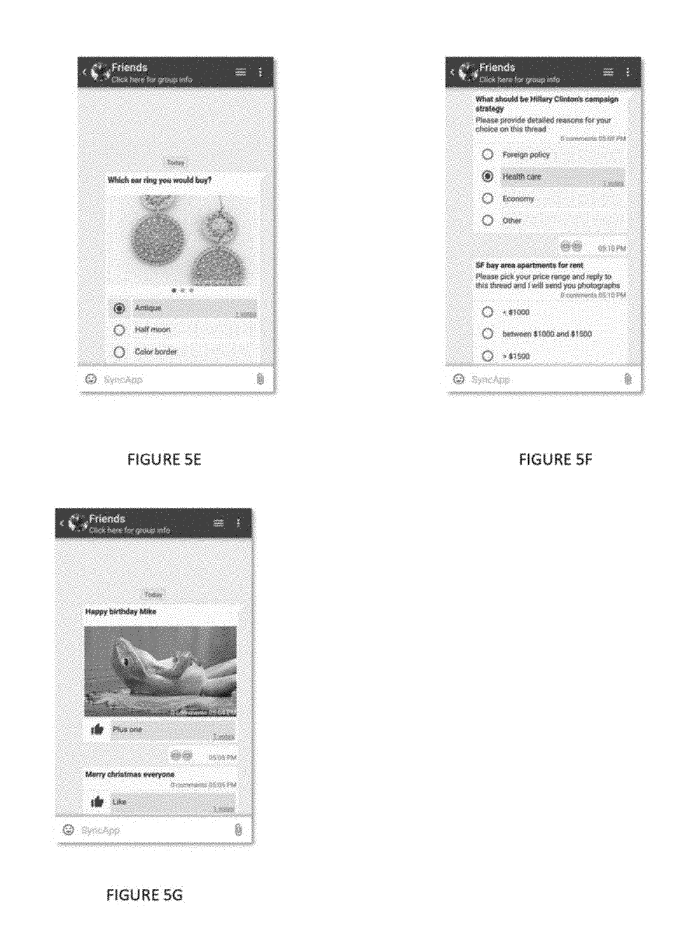

FIGS. 5A-G illustrate a set of example screen shots 500 illustrating example free-form shared objects, according to some embodiments. A free-form shared object as shown in the screen-shots 500 that can be used among interacting, parties for any purpose that includes, inter alia: consensus, coordination, routing, voting, agreement, trade, transaction, tracking, scheduling, sharing, matching and optimization. FIG. 5A illustrates an example of a voting-related free-form shared object. FIG. 5B illustrates an example of a consensus-related free-form shared object. FIG. 5C illustrates an example of an agreement-related free-form shared object. FIG. 5D illustrates an example of a scheduling-related free-form shared object. In the example of FIG. 5D, a simple forward of task list as in Tuesday's Schedule allows routing workflows where part of task can be completed and forwarded to next person in the assembly line. FIG. 5E illustrates an example of a trade-related free-form shared object. FIG. 5F illustrates an example of a voting-related free-form shared object. FIG. 5G illustrates an example of a wish-related free-form shared object (e.g. a ‘less noisy wish’),

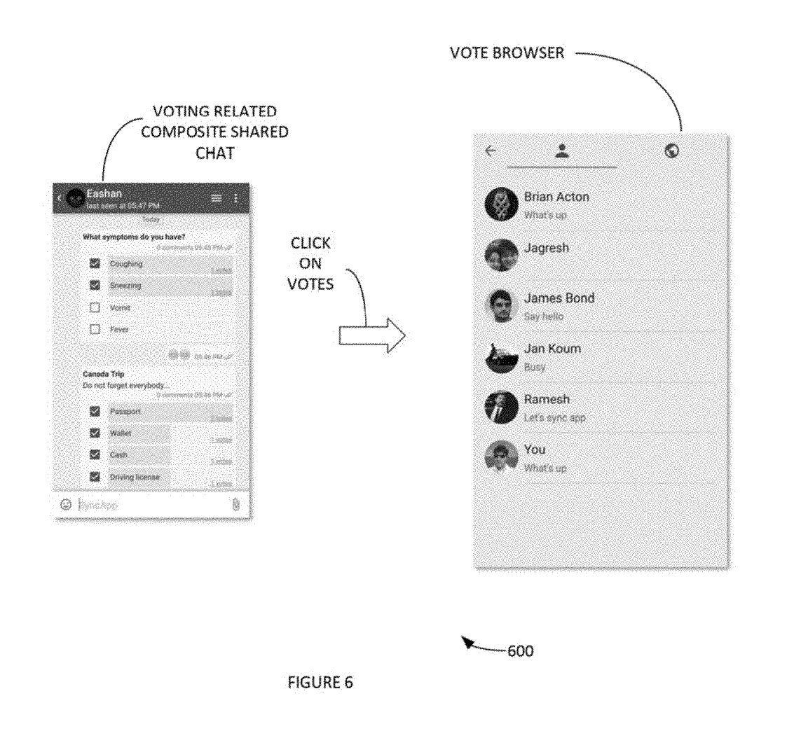

FIG. 6 illustrates an example screen shot 600 illustrating public-health related free-form shared object, according to some embodiments. In this example, an epidemic a doctor be required to communicate a large number (e.g. thousands, hundreds, etc.) of chat messages to notify a population of patients with a known specified set of disease-related symptoms (e.g. coughing, test results, etc.). Instead, the doctor (and/or other public health official) can perform a optimization search by reviewing vote count. For example, patients with a specified set of symptoms can vote to indicate that they have one or more of the symptoms.

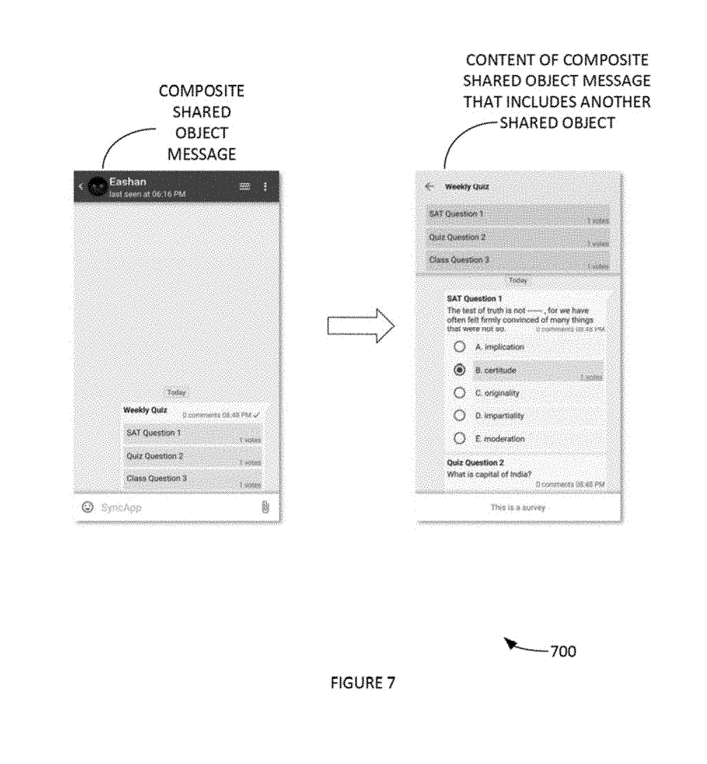

FIG. 7 illustrates an example screen shot 700 illustrating a composite-shared object that includes another shared object, according to some embodiments. When user clicks on the composite-shared object, it reveals one or more other (composite) shared objects that it contains. In the present example of FIG. 7, the composite-shared object is used to model quiz by a school teacher.

Both free-form shared objects and composite-shared objects can provide gamification of interactions between multi-parties. These parties can include, inter alia: several business verticals including health care, religion, education, manufacturing, trading, retail, cooking, entertainment, movies, sports, politics, reality TV shows etc. Shared objects can be saved as templates (e.g. for later reuse) and resent multiples times. This can enable a business to implement various workflows on a recurrent basis.

Privacy Controls of Shared Objects

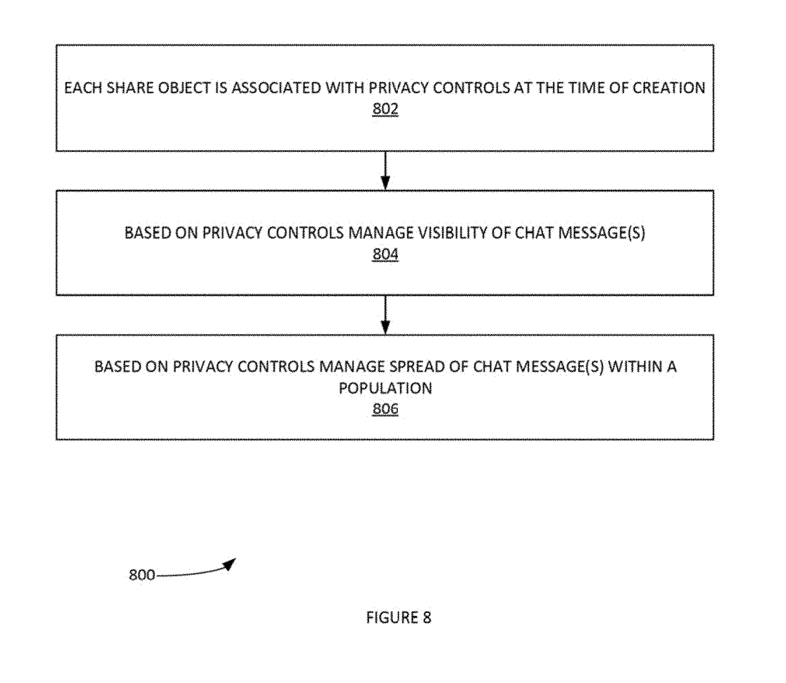

FIG. 8 illustrates an example process 800 for managing privacy controls of a shared-object chat message, according to some embodiments. In step 802, each share object is associated with privacy controls at the time of creation. In step 804, based on privacy controls process 800 can manage visibility of chat message(s). In step 806, based on privacy controls process 800 can manage spread of chat message(s) within a population.

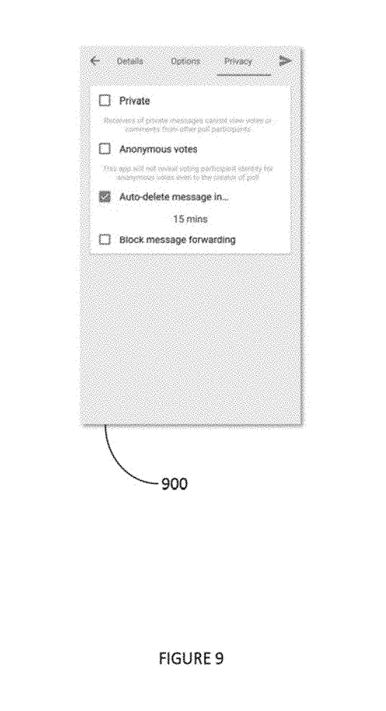

FIG. 9 illustrates an example screenshot 900 for managing privacy controls of a shared-object chat message, according to some embodiments. Each share object (e.g. a sticky) can be associated with privacy controls at the time of creation. These privacy controls can be used to manage visibility and spread within population. Privacy controls can facilitate various workflows in interviews, tests, hiring, reality TV shows, game commentaries.

Data Capture with Shared Objects

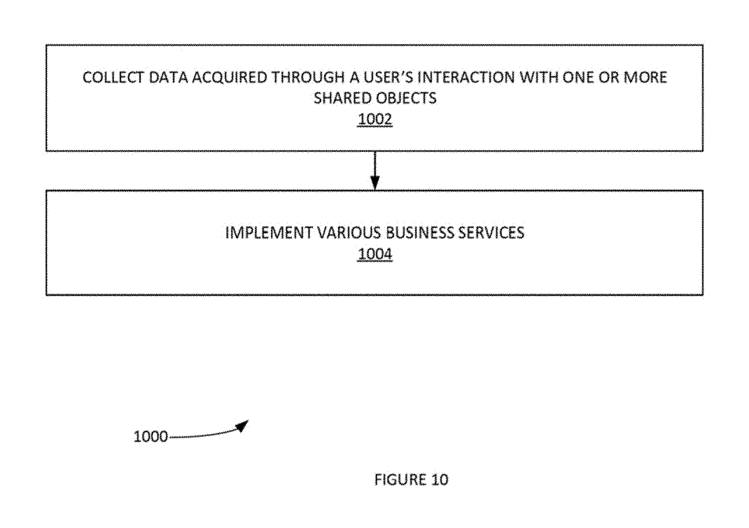

FIG. 10 illustrates an example process 1000 for analyzing data acquired through user's interaction, according to some embodiments. In step 1002, process 1000 can collect data acquired through user's interaction with shared object. Example data to be collected can include, inter alia: GPS location of vote, time of interaction with vote and history of interaction with other shared objects. These can enable process 1000 to provide a more personalized service with significantly low noise than other social networks.

Shared object(s) can provide discreet options which are more amenable to machine learning as opposed to free-form text or media within other networks which are less amenable to machine learning. Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia; decision tree learning, association rule learning, artificial neural networks, inductive logic programming, support vector machines, clustering, Bayesian networks, reinforcement learning, representation learning similarity and metric learning, and/or sparse dictionary learning.

In step 1002, process 1000 can implement various business services based on analytics of data collected in step 1000. For example, various business services can be designed to take advantage of the data captured. In one example, a manufacturing unit can provide a task list to its workers and determine an average time for tasks taken in a month and/or which workers are more skilled in particular task than others etc. A GPS location and/or time stamp ensures that a scheduled remote work like fixing A/C units, delivering goods etc. are done at right location and right time.

There are several methods which may be used to select a proper sample size and/or use a given sample to make statements (within a range of accuracy determined by the sample size) about a specified population. These methods may include, for example:

1. Classical Statistics as, for example, in “Probability and Statistics for Engineers and Scientists” by R. E. Walpole and R. H. Myers, Prentice-Hall 1993; Chapter 8 and Chapter 9, where estimates of the mean and variance of the population are derived.

2. Bayesian Analysis as, for example, in “Bayesian Data Analysis” by A Gelman, 1. B. Carlin, H. S. Stern and D. B. Rubin, Chapman and Hall 1995; Chapter 7, where several sampling designs are discussed.

3. Artificial Intelligence techniques, or other such techniques as Expert Systems or Neural Networks as, for example, in “Expert Systems: Principles and Programming” by Giarratano and G. Riley, PWS Publishing 1994; Chapter 4, or “Practical Neural Networks Recipes in C++” by T. Masters, Academic Press 1993; Chapters 15, and 20, where population models are developed from acquired data samples.

It is noted that these statistical methodologies are for exemplary purposes and other statistical methodologies can be utilized and/or combined in various embodiments. These statistical methodologies can be utilized elsewhere (e.g. in process 1000, other processes provided herein, etc.), in whole or in part, when appropriate as well.

Dynamic Grouping

Chat messages can be forwarded to users which may forward the chat messages to other users (e.g. multi-hopping of messages, etc.). A set of such users (e.g. a forward set) can be maintained an a per message basis so that system can notify them when the state of shared object changes.

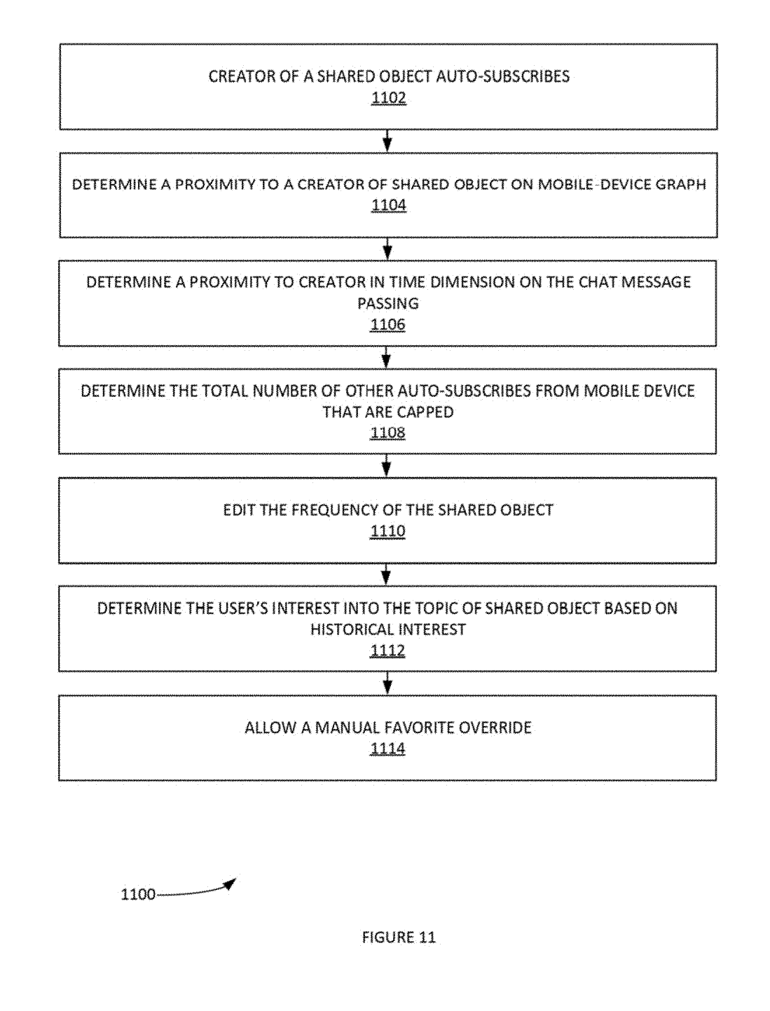

FIG. 11 illustrates an example process 1100 for providing dynamic grouping of shared-object chat messages, according to some embodiments. As such this forward set can be dynamically created in server based on the interest from a mobile device used for chat messaging. Each mobile device can subscribe to changes in shared objects based on its interest in the shared object. Process 1100 can be used to maximize application downloads. More specifically, process 1100 can implement the following steps.

In step 1102, the creator of a shared object auto-subscribes. In step 1104, process 1100 can determine a proximity to a creator of shared object on mobile-device graph. In step 1106, process 1100 can determine a proximity to creator in time dimension on the chat message passing. In step 1108, process 1100 can determine the total number of other auto-subscribes from mobile device that are capped. In step 1110, process 1100 can edit the frequency of the shared object (e.g. a high edit shared object may be noisy and low edit shared object may be uninteresting). In step 1112, process 1100 can determine the user's interest into the topic of shared object based on historical interest. In step 1114, process 1100 can allow a manual favorite override.

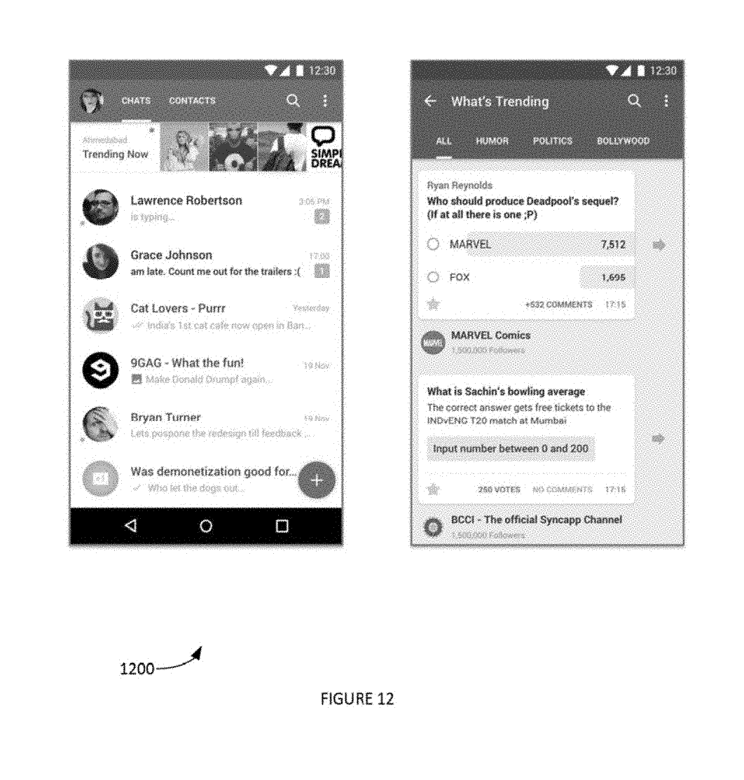

FIG. 12 illustrates a pair of example screen shots 1200 of example business services, according to some embodiments For example, business services like trending topics at a given location can be built from this data as shown in the screen shots below.

Matching Processes

In one example, a company wishes to hire programmers. The company communicates a quiz in a chat message(s) with intent of calling for physical interview of the top five percent (5%) of the quiz takers. In another example, a user can communicate a quiz about an ideal romantic partner. The user can then select the closest match from all the respondents to engage with.

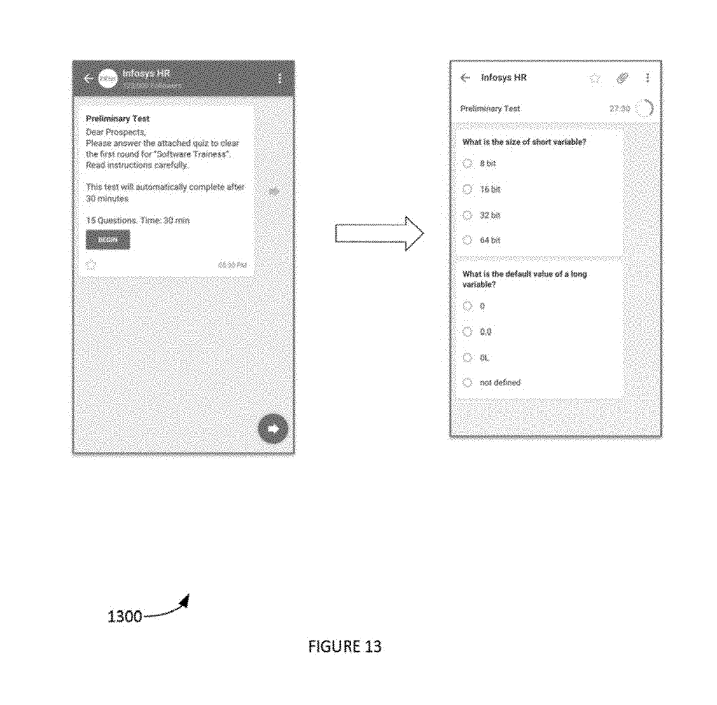

Accordingly, a matching system is provided. The matching system can enable a user to perform such data-mining using template based queries as shown in the screen shots of FIG. 13. Users can be matched with a given query with a chat message. Chat messages used for matching can include shared object(s). Shared objects can enable the user to obtain matching data related to the user's ideal match. The example illustrates an example sequence of chats a person used do to find a closest match

Send=>Sends out Quiz1 for creating candidate pool

Sender=>Sends out Quiz2 to all the matches of Quiz1 for filtering candidate pool

Sender=>Sends out Quiz3 to all the matches of Quiz2 for filtering further

In real life this might happen, Sender=>Quiz for marriage partner=>Quiz for personal compatibility=>Quiz for soul mate.

Various services and applications can utilize matching algorithms (e.g. matching two or more users based on a common set of attributes, etc.). These can include, inter alia: dating services, alliance services, counter-alliance services, etc. Lists in an aggregate report can be sorted based on location, reputation, rank etc. In some examples, any user, not just a sender, once he/she crosses a pay-wall and/or other friction can send messages to the list of their queries.

FIG. 13 illustrates an example set of screen shots 300 implemented in a matching process, according to some embodiments. Screen shots 1300 illustrate screen shots from receiver's perspective using an ephemeral quiz. The receiver can answer the provided questions. These answers can be used in a matching process. Screen shots 1300 show how a user receives a chat message with a test on an Infosys® HR channel. The user can also forward the test/quiz to friends and/or groups (e.g. in the user's chat message application contact list, etc.). Various receivers can supply answers to the test/questions. These can be stored in a database for later retrieval and analysis.

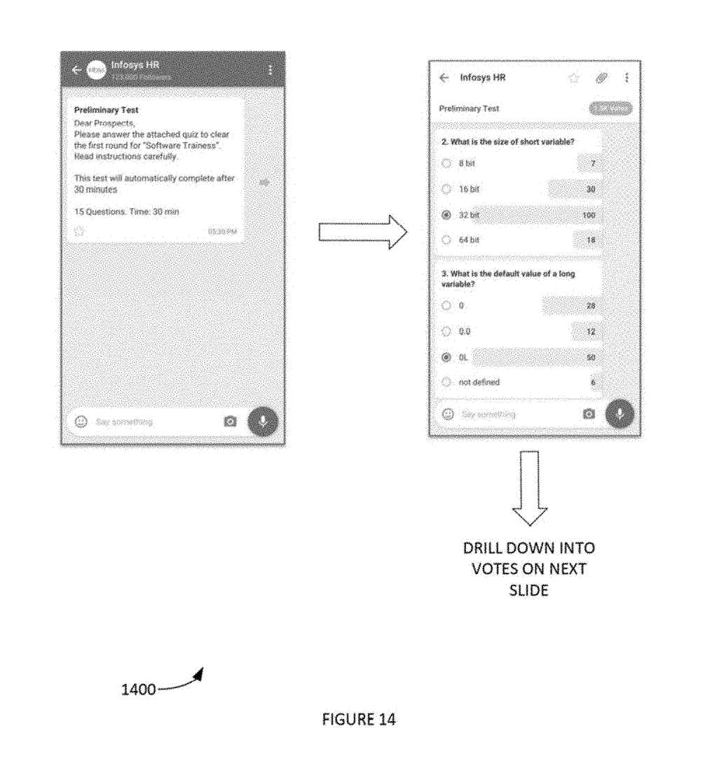

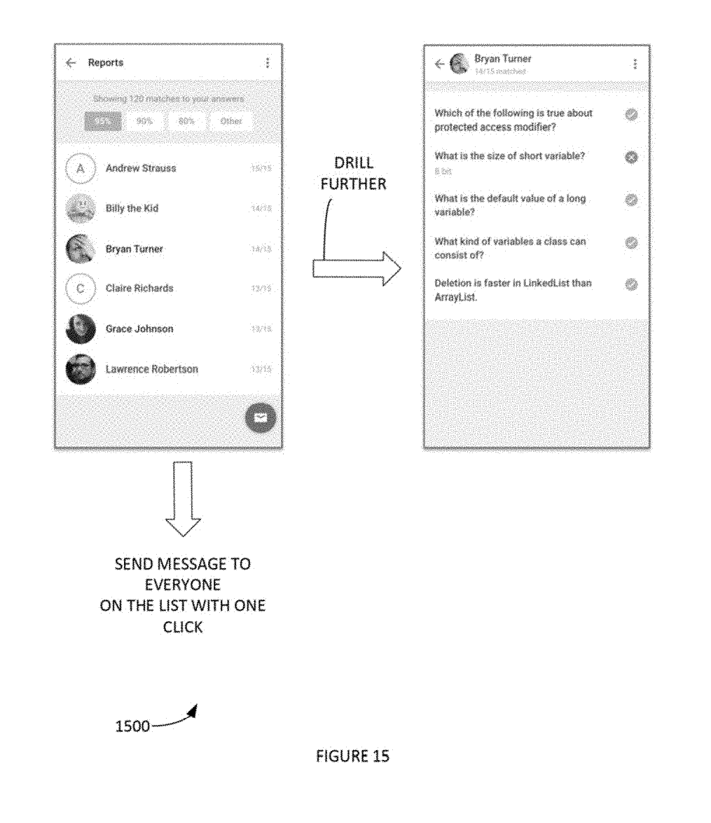

FIG. 14 illustrates an example set of screen shots 1400 implemented in a matching process, according to some embodiments. Screen shots 1400 are from a sender's (and/or report seeker's) perspective. The sender can send other tests on the channel (e.g. via various chat messages, etc.). The sender can click on the test and observe its results. Sender selects the answers to match to create the template query. Various other slides can provide aggregated and statistically summarized results. In this way, a sender can drill down into votes various slides as shown in FIG. 15.

FIG. 15 illustrates an example set of screen shots 1500 implemented in a matching process, according to some embodiments. Screen shots 1500 illustrate an aggregated report about matching (e.g. showing 14/15 matches etc.). The reviewer/sender can send message to everyone on the list (e.g. test/quiz taker, etc.) with one click.

Shared-Object Chat Message Services

Free form and composite shared object when combined with forwarding and matching facilities allows a wrapper or context within which these inventions can coexist. To expose this context to the users we have invented two new concepts called Channels and Exchanges. Channels and Exchanges are new kind of peer-to-peer services as opposed to well-known client-server services of the web era. Channels and Exchanges allow us to get into all kinds of enterprises, barter exchanges, virtual malls, real time data feeds, e-governance, e-healthcare, e-education, e-religion etc.

A channel is k=>n, k hosts are posting to n followers where k<<n

Whereas an exchange is, n=>n followers are posting to k hosts where k<<n

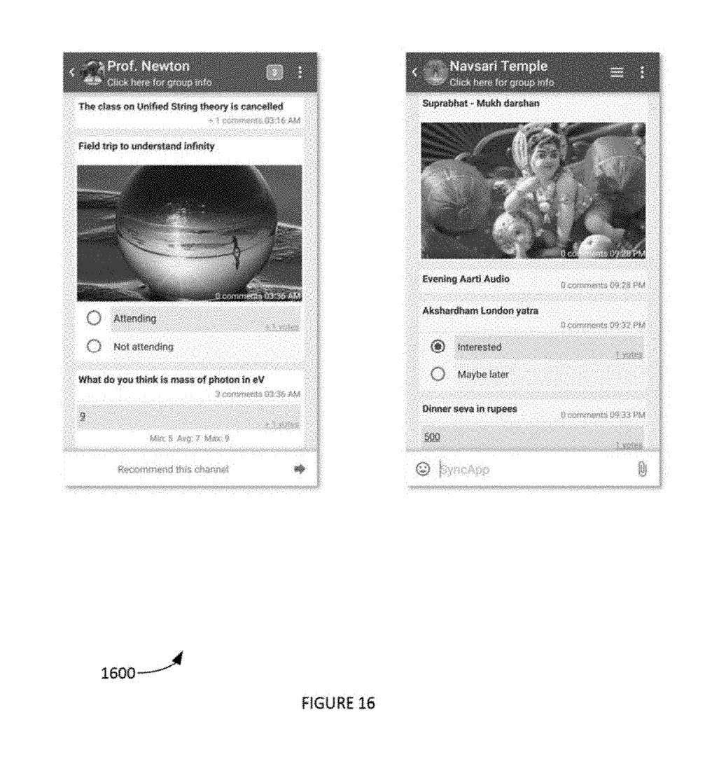

FIG. 16 illustrates an example pair of screen shots 1600 of a small clique channel example, according to some embodiments. Screen shots 1600 illustrates a channel hosted by Professor Newton for fifty (50) students and a channel hosted by a temple for its community. Channels can enable channel hosts to gamify their relations with followers. A channel can be a mechanism for k hosts to communicate with n followers such that k is much larger than n. A channel can be a conduit for shared objects where hosts determine the topics of information exchange and engage n followers. Channels can enable of guided communication.

In the present example on screen shot 1600, the channels enable a bottom up information flow where people of lesser influence than celebrities corporations such as, inter alia: professors, doctors, lawyers etc. Users can use channels to conduct business and engage their audience. Each of specified channel follower relationship represents a clique in the social graph of world. This mechanism provides various cliques like the one on the side can come into existence. The creativity and influence of channel centroid (e.g. channel host is utilized to discover the cliques and distribute these cliques in a social network, etc.).

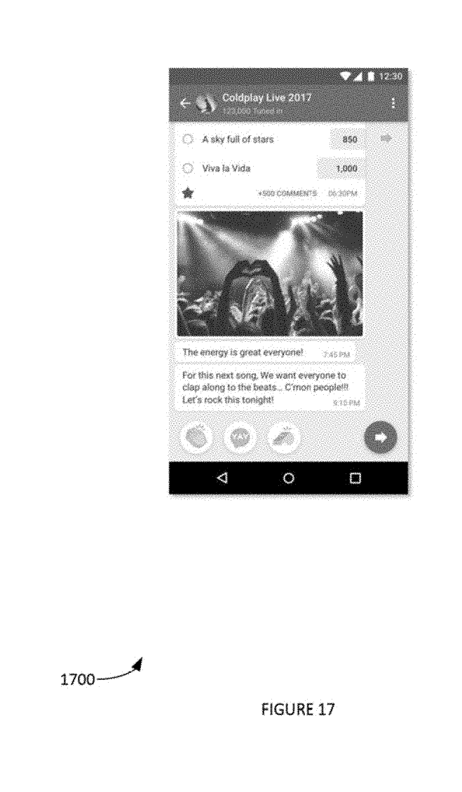

FIG. 17 illustrates an example pair of screen shots 1700 of a large clique channel example, according to some embodiments. A channel can have large number of followers receiving directions in real-time from a channel host. A large clique channel can be used in an interactive concert (e.g. see infra). A large clique channel can provide, for example, directions to clap, whistle and shouts are given by concert host. A clap and whistle functionality can play on the phone itself as shown in the screen on the side. Large cliques (e.g. concerts, games, rallies, MOOCS, etc.) can self-organize and sequence their steps sympathetic to a certain outcome. Other possible large cliques can include experts/institutions/organizations reaching out to their audience on a channel. The channel hosts can range from TV hosts to news reporters, to celebrities etc. with manifold possibilities of directing, querying, reaching out and gamifying their relationships with their followers.

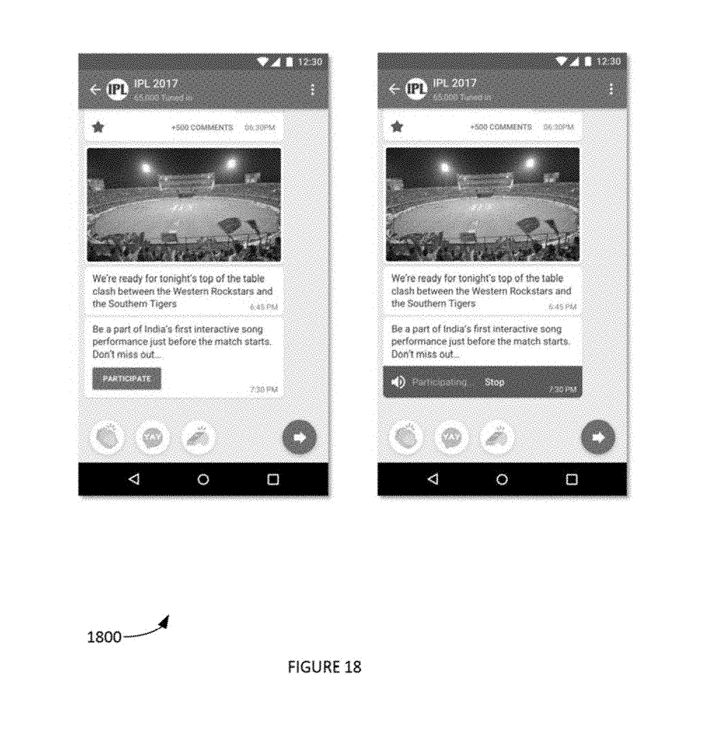

FIG. 18 illustrates an example pair of screen shots 1800 of a live clique channel example, according to some embodiments. The example of FIG. 17 can be extended further. In one example, a follower gives control of phone speakers to channel hosts. All the followers of a sports game or other event within a stadium can participate in an interactive song. A follower can provide control of the phone speakers to channel hosts momentarily (e.g. for a specified period of time). A slide channel host can use a specified number of these phone devices in the stadium in synchrony to create a distributed song performance.

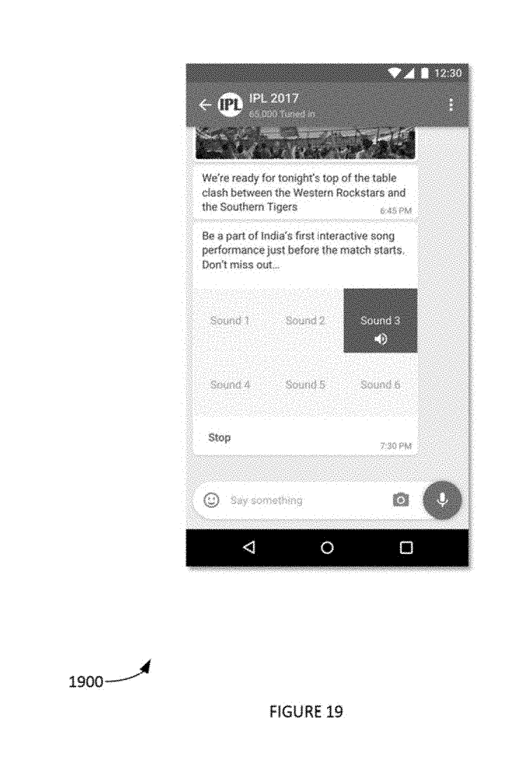

FIG. 19 illustrates an example pair of screen shots 1900, according to some embodiments. Screen shots 1900 shows an example big-game channel from a channel host perspective. A distributed song can be play using this mechanism. Channel hosts can use sound keyboard to play the song live across all the participating phones of the stadium. The keyboard can be piano keyboard and/or drums key pad etc. This is mobile version of every one in a large rally lighting a match stick. This example is provided by way of illustration and not limitation.

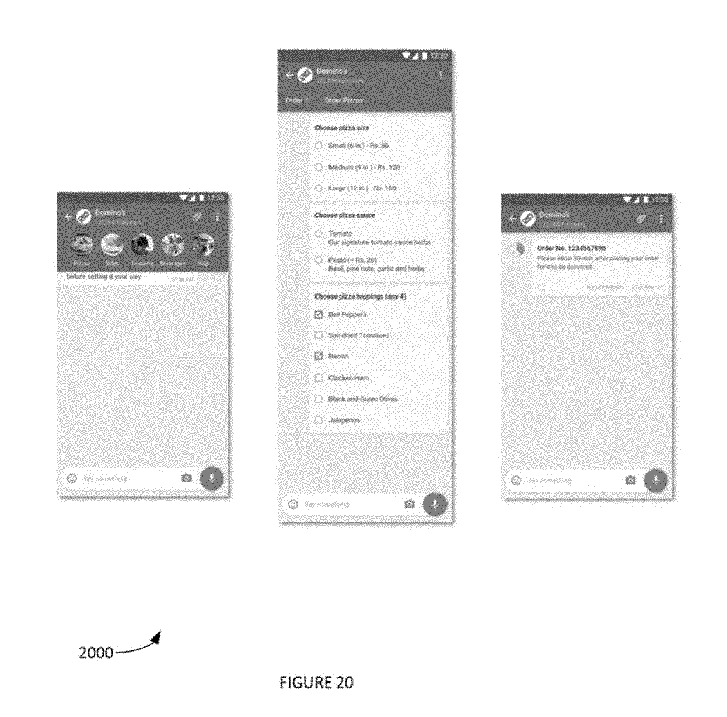

FIG. 20 illustrates an example set of screen shots 2000 of an exchange example, according to some embodiments. In an exchange example a follower can view exchanges. Exchanges can enable people to discuss via chat messages and to exchange hosts as shown in screen shots 2000. In exchange host view, various orders can flow to a sender's account. In one example, a pizza provider can create a custom attachment menu through which it can receive millions of orders from the exchange followers. An exchange example can use the other systems and process provided supra, as well as, custom attachments, custom keyboards, shared objects, shared context and ephemeral messaging for the purpose of conducting its business. A variety of such exchanges can enable various implementers to create virtual malls, barter exchanges, flea markets all on a generic technology platform.

Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method useful for providing a dynamic grouping of a set of shared-object chat messages comprising:
enabling a creator of a shared object to auto-subscribe to a dynamic grouping of shared-object chat messages service;
determining a proximity to a creator of a shared object on mobile-device graph;
determining a proximity to a creator in a time dimension on a chat message passing;
determining a total number of other auto-subscribes from a mobile device that are capped; and
editing a frequency of the shared object.

2. The computerized method of claim 1 further comprising:
determining a user's interest into a topic of the shared object based on historical interest.

3. The computerized method of claim 2, wherein the shared object comprises a free-form shared object.

4. The computerized method of claim 2, wherein the shared object comprises a composite shared object.

5. The computerized method of claim 4, wherein the composite shared object comprises can be a shared object with a plurality of forms.

6. The computerized method of claim 5, wherein the composite shared object comprises a set of other shared objects.

7. The computerized method of claim 2 further comprising:
enabling a manual favorite override.

8. A computerized system useful for useful for providing a dynamic grouping of a set of shared-object chat messages comprising:
a processor configured to execute instructions;
a memory containing instructions when executed on the processor, causes the processor to perform operations that:
enable a creator of a shared object to auto-subscribe to a dynamic grouping of shared-object chat messages service;
determine a proximity to a creator of a shared object on mobile-device graph;
determine a proximity to a creator in a time dimension on a chat message passing;
determine a total number of other auto-subscribes from mobile device that are capped; and
edit a frequency of the shared object.

9. The computerized system of claim 8, wherein the memory containing instructions when executed on the processor, causes the processor to perform operations that:
determine a user's interest into a topic of the shared object based on historical interest.

10. The computerized system of claim 8, wherein the shared object comprises a free-form shared object.

11. The computerized system of claim 8, wherein the shared object comprises a composite shared object.

12. The computerized system of claim 11, wherein the composite shared object comprises can be a shared object with a plurality of forms.

13. The computerized system of claim 12, wherein the composite shared object comprises a set of other shared objects.
